(19) United States
(12) Patent Application Publication
(10) Pub. No.: US 2003/0074671 A1
(43) Pub. Date: Apr. 17, 2003

(54) Method for information retrieval based on network

(76) Inventors: Tomokazu Murakami, Tokyo (JP); Masahiro Kageyama, Hino (JP); Hisao Tanabe, Hachioji (JP)

Correspondence Address: Mattingly, Stanger & Malur, P.C., Suite 370, 1800 Diagonal Road, Alexandria, VA, 22314, US

(21) Appl. No.: 10/073,972

(22) Filed: Feb. 14, 2002

(30) Foreign Application Priority Data
Sep. 26, 2001 (JP) 2001-292784

(51) Int. Cl. H04N 7/173

(52) U.S. Cl. 725/109; 725/112

(57) ABSTRACT

In an information system wherein an information registering equipment, an information viewing equipment, and an information search equipment are interconnected by a computer network, a method of linking an object selected from content of interest rendered by media with its reference information and keyword information is disclosed. The information registering equipment transmits content/object identifying information to identify the area defined for the object selected from the content of interest, its reference information or a link to the reference information, and its keyword information to the information search equipment over the computer network. The information viewing information transmits the content/object identifying information and/or its keyword information to the information search equipment over the computer network. The information search equipment compares the content/object identifying information specifics and/or the keyword information specifics received from the information viewing equipment and the information registering equipment for matching. If matching occurs, the information search equipment transmits the reference information to the information viewing equipment over the computer network.

### BACKGROUND OF THE INVENTION

The present invention relates to a system for rendering information related to a displayed video image distributed by TV broadcasting and other means and programs for software implementations of an information viewing equipment, information registering equipment, and information search equipment, based on such information rendering method.

On a computer network called the Internet, information stored on sites interconnected by the network is linked together by means called hyperlinks and a virtually huge information database system called the World Wide Web (WWW) is built. In general, a Web site consists of Web pages including a home page as a beginning file, which are regarded as units of information accessible. On the Web pages, information such as text, sound, and images is linked one another by means of a hypertext-scripting language called HTML (Hyper Text Markup Language). One Web site links to another Web site by HTML, thereby forming a distributed information database system at different sites interconnected by the network.

Not only bushiness users, but also general personal users can gain access to Web sites and pages by using browsing software (hereinafter referred to as a browser) run on a personal computer (PC). For improving user facilities, such a search service (hereinafter referred to as a directory service) is provided on the WWW that enables ready access to target information on a Web site/page, according to a keyword or the like entered.

With digital broadcasting using broadcasting satellites, it is possible that a plurality of information contents are linked up and that a TV program and information distributed on the Internet are linked up by using scripting languages as extensions of the HTML function for broadcasting, such as BML (Broadcast Markup Language), B-XML (Broadcast extensible Markup Language), and B-HTML (Broadcast HTML). Information described in these scripting languages is transmitted to users by means of framing such as standardized data broadcasting.

### SUMMARY OF THE INVENTION

If users (audience of TV programs) should use a function that enables the user, by selecting a part or all of a video image displayed on a TV receiver when watching a TV program, to obtain information related to the video image, it would be convenient for them. For example, if the audience should select (click) a costume that an actress wears who acts the heroine of a drama program on the air with a pointing device such as a mouse, reference information related to the costume, such as its supplier name and price, would be displayed on the TV monitor screen. In addition to such manner of specifying information to be retrieved by clicking an object on a video image, a method of specifying information to get by using a keyword (for example, the costume's brand name) in combination of the above manner, if available, would make it possible to obtain information efficiently. In assumed application of a system that could link a video image to its reference information as described above, the same object (for example, the same actress if a drama is the content of interest) would appear repeatedly in a sequence of video streams. In order to collect information linked to the same object in different scenes over time, particularly, it is essential to practical use of such system to manage an object by a keyword relevant to the object. By linking up video image information, keyword, and reference information, a new information database could be built that allows for the combination of a search method based on a sensuously selected object on a video image and an exhaustive search method based on a keyword.

In order to realize the above function, it is necessary to provide a method of linking information one another, an information registering equipment, information viewing equipment, and information search equipment. How to provide them is a great challenge as problems to solve.

As the method of linking information one another, a method of linking a video image object, reference information, and keyword information together is required. Although conventional search engines for the above-mentioned directory service implemented linking a keyword to its reference information, there, so far, has not been existed a method of linking three things, a keyword, a video image object, and its reference information one another. It is required that a new information linking method that enables interconnection of a video image object, reference information, and keywords by a direct link should be provided.

As equipment to implement operations by the above new information linking method, an information registering equipment, information viewing equipment, and information search equipment are required. For the information registering equipment, it is required that equipment that enables the provider of information related to a video image object (who is hereinafter referred to as the registrar) to link the video image object, its reference information and keywords by easy operation should be provided. For the information viewing equipment, it is required that equipment that enables the information viewer to retrieve and view the reference information by selecting a part or all of a video image object, entering a keyword, or specifying image object information in combination with a keyword as conditions of search should be provided. For the information search equipment, it is required that equipment that is able to efficiently store information registered by the information registering equipment into a database, search for target information registered thereon, according to the search request from the information viewing equipment, and transmit the result of search to the information viewing equipment should be provided.

With the aim of solving the foregoing problems, the object of the present invention is to provide an information rendering system, information viewing equipment, information registering equipment, information search equipment, and programs for software implementations of such system and equipments.

Representative subject matters of the invention disclosed herein are summarized below:

An information rendering system comprising an information registering equipment, an information viewing equipment, and an information search equipment which are interconnected by a network is provided. The information registering equipment comprises: means for inputting first content/object identifying information that identifies a selected area on an image displayed from content of interest rendered by media, reference information, and first keyword information about the selected area; and means for transmitting the thus entered information across the network to the information search equipment. The information viewing equipment comprises: means for inputting second keyword information about the content of interest or the second keyword information, and second content/object identifying information that identifies a selected area on an image displayed from the content of interest; and means for transmitting the thus entered information to the information search equipment. The information search equipment comprises: means for linking the first content/object identifying information, the reference information, and the first keyword information together and storing them; means for comparing the first and second information specifics of the same type for matching or duplication; means for transmitting the reference information associated with the first keyword information or the first keyword information and the first content/object identifying information from among the stored reference information items, according to the result of the matching, to the information viewing equipment. Because content/object identifying information, reference information, and keyword information are linked and registered on the information search equipment, another embodiment of information to be input from and output to the information viewing equipment is also conceivable.

Moreover, such computer programs are disclosed as will be recited below. A computer program for causing the information search equipment to perform the process of information processing comprising the steps of: obtaining first content/object identifying information that identifies area defined for an object selected from the content of interest, first keyword information, and first reference information about the object within the defined area from the information registering equipment; linking the first content/object identifying information, the first keyword information, and the first reference information together and storing them into a database; obtaining second keyword information about an object selected from the content of interest from the information viewing equipment; comparing the thus obtained first and second keyword information specifics for matching; and transmitting at least either the first content/object identifying information or the first reference information associated with the first keyword information to the information viewing equipment, according to the result of the matching. A computer program for causing the information registering equipment to implement the process of information processing comprising the steps of: making inquiry about an object selected from the content of interest rendered by media to the information search equipment connected to the information registering equipment by the network; receiving and displaying keyword information about the object selected from the content of interest from the information search equipment; allowing for entering content/object identifying information that identifies the area defined for the object selected from the content of interest; allowing for selecting one or more keywords from the displayed keyword information; allowing for entering reference information associated with the entered content/object identifying information; and transmitting the content/object identifying information, the selected keyword or keywords, and the reference information to the information search equipment.

A computer program for causing the information viewing equipment to implement the process of information processing comprising the steps of: making inquiry about an object selected from the content of interest rendered by media to an information search equipment connected to the information viewing equipment by the network; receiving and displaying keyword information about the object selected from the content of interest from the information search equipment; allowing for entering content/object identifying information that identifies the area defined for the object selected from the content of interest; allowing for selecting one or more keywords from the displayed keyword information, transmitting the selected keyword or keywords and the content/object identifying information to the information search equipment; and receiving and displaying reference information associated with the content/object identifying information and the keyword information from the information search equipment.

These and other objects, features, and advantages of the present invention will become more apparent in view of the following detailed description of the preferred embodiments in conjunction with accompanying drawings.

### BRIEF DESCRIPTION OF THE DRAWINGS

FIG. 1 shows a schematic structural drawing of a preferred embodiment of the present invention;

FIG. 2 shows a structural drawing of embodiment of the information registering equipment and the information viewing equipment according to the present invention;

FIG. 3 shows a structural drawing of another embodiment of the information registering equipment and the information viewing equipment according to the present invention;

FIG. 4 illustrates an example of information linking operation according to the present invention;

FIG. 5 illustrates another example of information linking operation according to the present invention;

FIG. 6 illustrates yet another example of information linking operation according to the present invention;

FIG. 7 illustrates an example of the information displayed on the information viewing equipment of the present invention;

FIG. 8 illustrates an example of displaying content on the display of the information viewing equipment of the present invention;

FIG. 9 illustrates another example of displaying content on the display of the information viewing equipment of the present invention;

FIG. 10 illustrates an example of displaying content on the displays of the information registering equipment of the present invention;

FIG. 11 illustrates examples of data tables and data records which are used in the present invention; and

FIG. 12 illustrates an exemplary method of judging whether the clicked position falls within the previously defined and registered area.

### DESCRIPTION OF THE PREFERRED EMBODIMENTS

With reference to the accompanying drawings, preferred embodiments of the present invention will be described below.

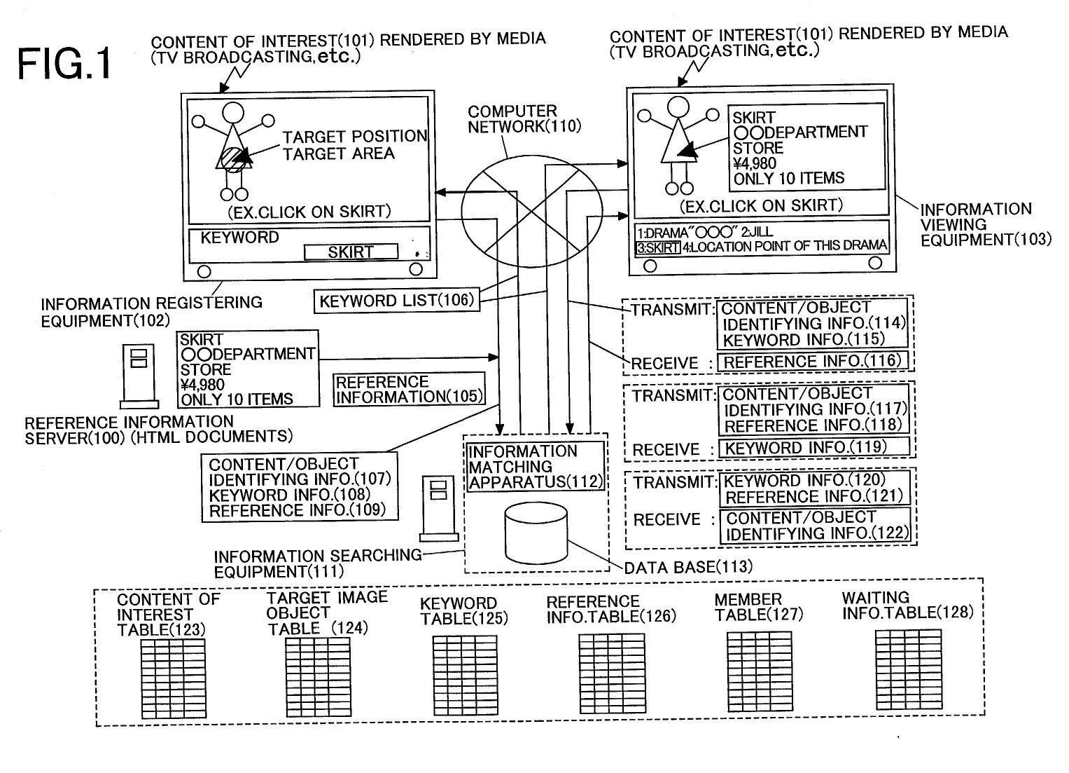

FIG. 1 shows a schematic structural drawing of a preferred embodiment of the present invention. First, content of interest (101) rendered by media is input to both an information registering equipment (102) and an information viewing equipment (103). This content of interest is the same input for both equipments. The content of interest may be any distinguishable one for both equipments independently (that is, it is distinguishable from another content rendered by media), including a video image of a TV broadcast, packaged video content such as DVD video available on the market, streaming video content or an image from a Web site/page distributed over the Internet or the like, and a video image of a scene whose location and direction are identified by a Global Positioning System (GPS). On the assumption that the content of interest (101) is rendered by TV broadcasting, operation according to the preferred embodiment will be explained below.

On the information registering equipment (102), the content of interest is displayed and its reference information (105) stored in a form such as a text document and HTML document on a reference information server (104) that is provided internally in the same registering equipment or as an external equipment, the video image reproduced from the content of interest, and a keyword associated therewith are linked together. During this operation, on the displayed image, target position/area are defined with a coordinates pointing device (such as a mouse, tablet, pen, remote controller, etc.) included in the information registering equipment. As an example, defining the target position/area by clicking on a skirt in the displayed image is represented in FIG. 1. The thus defined target position/area and information to identify the content of interest are combined into information to identify a selected area on an image displayed from the content of interest (the information is hereinafter referred to as content/object identifying information (107)) that is transmitted. If, for example, the content is rendered by TV broadcasting, as the information to identify the content of interest, the following may be used: broadcast channel number, time when the content was broadcasted (year, month, day, hours, minutes, seconds, frame number, etc.), receiving area (in the case of local TV broadcasting), etc. According to the time when the content was broadcasted, time length information is specified. As the target position/area information, information to specify the shape of the area (such as, for example, a circle) and parameters (if the shape is a circle, the coordinates of its center and its radius) may be used. Reference information and keyword information are entered by using an input device (keyboard) or the like connected to the information registering equipment. Keyword information may be specified in such a manner as will be described below. By accessing the information search equipment (111) beforehand, a keyword list (106) which has previously been registered is received therefrom and a keyword is selected from the keyword list and linked to other information. The contents of content/object identifying information, keyword information, and reference information will be described later. The information registering equipment transmits the content/object identifying information (107), keyword information (108) and reference information (109) to which the object and keyword are desired to link across a computer network (110) to an information search equipment (111). Hereon, the reference information (109) may be the same as the reference information (105) stored on the reference information server (104). If the content is to link to an open HTML document or the like on a Web site/page accessible over the Internet, the reference information (109) may be a character string of URL (for example, http://www.???.co.jp/) that designates the address where the document exists.

On the other hand, on the information viewing equipment (103), similarly, the content of interest is displayed. On the displayed image, target position/area are defined with a coordinates pointing device included in the information viewing equipment. The information viewing equipment tries to retrieve and output (display) reference information linked to the thus defined position/area. To do this, the information viewing equipment transmits the content/object identifying information (114) and/or keyword information (115), which are specified in the same way as described above, across the computer network (110) to the information search equipment, then waits for results of search to be returned therefrom. Keyword information may be specified in such a manner that, by accessing the information search equipment beforehand, a keyword list (106) which has previously been registered is received therefrom and a keyword is selected from the keyword list. The thus selected keyword may be transmitted to the information search equipment and search will be performed, based on the keyword. By displaying the reference information (116) returned from the information search equipment on the display screen, the information viewing equipment achieves linking the content of interest (101) to the reference information (105).

In another mode of information retrieval, the information viewing equipment tries to retrieve and output keyword information (119) instead of the reference information (116). To do this, the information viewing equipment transmits the content/object identifying information (117) and/or reference information (116) across the computer network (110) to the information search equipment, then waits for results of search to be returned therefrom. In this case, the information viewing equipment receives and displays the keyword information (119) returned from the information search equipment in the same procedure as for reference information retrieval.

In yet another mode of information retrieval, the information viewing equipment tries to retrieve and output content/object identifying information (122). To do this, the information viewing equipment transmits keyword information (120) and/or reference information (121) across the computer network (110) to the information search equipment, then waits for results of search to be returned therefrom. In this case, the information viewing equipment receives and displays the content/object identifying information (122) returned from the information search equipment in the same procedure as for other cases illustrated above. The content/object identifying information, reference information, and keyword information will be explained later.

The information search equipment (111) is comprised of an information matching apparatus (112) and a database (113). The information search equipment registers the content/object identifying information (107), keyword information (108), and reference information (109) to which the object and keyword are desired to link, received from the information registering equipment (102), into the database (113) as a data record. At the same time, the information matching apparatus (112) matches the content/object identifying information, keyword information, and reference information received from the information viewing equipment (103) with the data records stored in the database. If there is a match between a plurality of content/object identifying information, a plurality of keyword information, or a plurality of reference information, or if a data record satisfies the conditions for matching in the combination of content/object identifying information, keyword information, and reference information, the information search equipment transmits the registered reference information, keyword information, or content/object identifying information from the matched data record (if there are a plurality of items of such information, a block of items) across the computer network (110) to the information viewing equipment (103). The method of matching will be described later. The database includes data tables: a content of interest table (123) to contain content identifying information specifics such as time when the content was TV broadcasted and TV program; a target image object table (124) to contain image objects and specifics such as target position/area selected and registered by the information registering equipment; a keyword table (125) to contain keywords and specifics registered by the information registering equipment; a reference information table (126) to contain reference specifics registered by the information registering equipment; a member table (127) to contain user management information specifics for users who may gain access to the information search equipment by using the information registering equipment or information viewing equipment; and a waiting information table (128) to contain information that is used for executing search again after the elapse of a certain time if reference information meeting the conditions of search failed to be found in spite of the inquiry about reference information made from the information viewing equipment. By using the content of interest table, keyword information and reference information can be managed on a per-TV-program basis even if a TV broadcast program is broadcasted over different channels and at different hours across the TV broadcasting areas. Data record examples will be described later. As the information matching apparatus and the database, a general database server can be used, and therefore a drawing thereof is not shown.

On the information search equipment, search and matching are performed in methods that differ for reference information, keyword information, and content/object identifying information to be retrieved.

A case where reference information is retrieved is first explained below. Searching for reference information is performed by using content/object identifying information (114), keyword information (115), or the combination of content/object identifying information (114) and keyword information (115) received from the information viewing equipment.

Searching for reference information by using content/object identifying information is as follows. Information identifying the content of interest and target position/area information constituting the content/object identifying information (114) are compared with the corresponding ones in the records stored in the database, previously registered by the information registering equipment. A record having the data that completely or partly matches the target position/area is retrieved and the reference information linked with that data is transmitted to the information viewing equipment. Searching for reference information by using keyword information is as follows. A keyword or keywords constituting the keyword information (115) received from the information viewing equipment are compared with the keyword data in the records stored in the database, previously registered by the information registering equipment. A record having the data that completely or partly matches the keyword or keywords is retrieved and the reference information linked with that data is transmitted to the information viewing equipment. Instead of a keyword, ID code representing the keyword may be used. In addition to keyword comparison, time length limitation placed on a keyword may be included in the conditions of search. As the time length information, available are the following: time information for the reference information linked with a keyword; time when the keyword was registered; and time when the reference information was registered. For example, such a search method is conceivable that the database is searched for reference information that is linked with a keyword (for example, “skirt”) and content/object identifying information in which time length within one hour from the current time is specified. Alternatively, such a search method may be used that the database is searched for reference information that is linked with a keyword and the reference information is retrieved, provided the time when the reference information or the keyword was registered is within one hour from the current time. Searching for reference information by using the combination of content/object identifying information and keyword information is as follows. The above searching for reference information by using content/object identifying information and the above searching for reference information by using keyword information are carried out together. For example, such a search method is practicable that, assuming that selected area on a displayed image of a specified TV program in specified time length is set as content/object identifying information, the database is searched for reference information that is linked with the content/object identifying information and a particular keyword. Alternatively, such a search method is practicable that the database is searched for reference information linked with specific content/object identifying information and reference information linked with a particular keyword at the same time. Moreover, such a search method is practicable that the database is once searched for reference information linked with specific content/object identifying information, then searched for keyword information linked with the thus retrieved reference information, and again searched for another reference information linked with the keyword information retrieved. The above-described methods of search enable the following. By clicking an object on the display of the information viewing equipment and thus selecting the target area on the displayed image, its reference information is retrieved, and in addition, its reference information is retrieved by specifying a keyword about the abject.

Then, a case where keyword information is retrieved is explained. Searching for keyword information is performed by using content/object identifying information (117), reference information (118), or the combination of content/object identifying information (117) and reference information (118) received from the information viewing equipment.

Searching for keyword information by using content/object identifying information is as follows. Information identifying the content of interest and target position/area information constituting the content/object identifying information (117) are compared with the corresponding ones in the records stored in the database, previously registered by the information registering equipment. A record having the data that completely or partly matches the target position/area is retrieved and the keyword information linked with that data is transmitted to the information viewing equipment. Searching for keyword information by using reference information is as follows. Character strings of URLs and comments constituting the reference information (118) received from the information viewing equipment are compared with the corresponding ones in the records stored in the database, previously registered by the information registering equipment. A record having the data that completely or partly matches the strings of URLs and comments is retrieved and the keyword information linked with that data is transmitted to the information viewing equipment. Searching for keyword information by using the combination of content/object identifying information and reference information is as follows. The above searching for keyword information by using content/object identifying information and the above searching for keyword information by using reference information are carried out together.

Then, a case where content/object identifying information is retrieved is explained. Searching for content/object identifying information is performed by using keyword information (120), reference information (121), or the combination of keyword information (120) and reference information (121) received from the information viewing equipment.

Searching for content/object identifying information by using keyword information is as follows. A keyword or keywords constituting the keyword information (120) are compared with the keyword data in the records stored in the database, previously registered by the information registering equipment. A record having the data that completely or partly matches the keyword or keywords is retrieved and the content/object identifying information linked with that data is transmitted to the information viewing equipment. Searching for content/object identifying information by using reference information is as follows. Character strings of URLs and comments constituting the reference information (121) received from the information viewing equipment are compared with the corresponding ones in the records stored in the database, previously registered by the information registering equipment. A record having the data that completely or partly matches the strings of URLs and comments is retrieved and the content/object identifying information linked with that data is transmitted to the information viewing equipment. Searching for content/object identifying information by using the combination of keyword information and reference information is as follows. The above searching for content/object identifying information by using keyword information and the above searching for content/object identifying information by using reference information are carried out together.

In the foregoing, the case where reference information is retrieved, the case where keyword information is retrieved, and the case where content/object identifying information is retrieved have been described separately. However, it may be carried out that reference information, keyword information, and content/object identifying information are retrieved together and a plurality of the retrieved ones are transmitted in a block to the information viewing equipment.

The details on the content/object identifying information, keyword information, and reference information that are linked up and stored are described below. As the content/object identifying information, TV broadcast channel numbers, receiving area, specified time length information, target image object information that designates a part or all of a target image object, etc. may be used. As the keyword information, a keyword, ID number representing a keyword, keyword type information, time length information about reference information linked with a keyword, time when the keyword was registered, the number of times the keyword has been selected as user preference, etc. are used. One keyword is not always one word; that is, it may consist of a plurality of words. One keyword is not limited to one or more words; that is, it may consist of a key sentence. A character string of a keyword may include symbols. As the reference information, a URL that designates a Web site/page accessible over the Internet, text, graphics, etc. are used. As text, for example, comments on the contents of a Web site/page designated by a URL, catch phrases for introduction, etc. may be written.

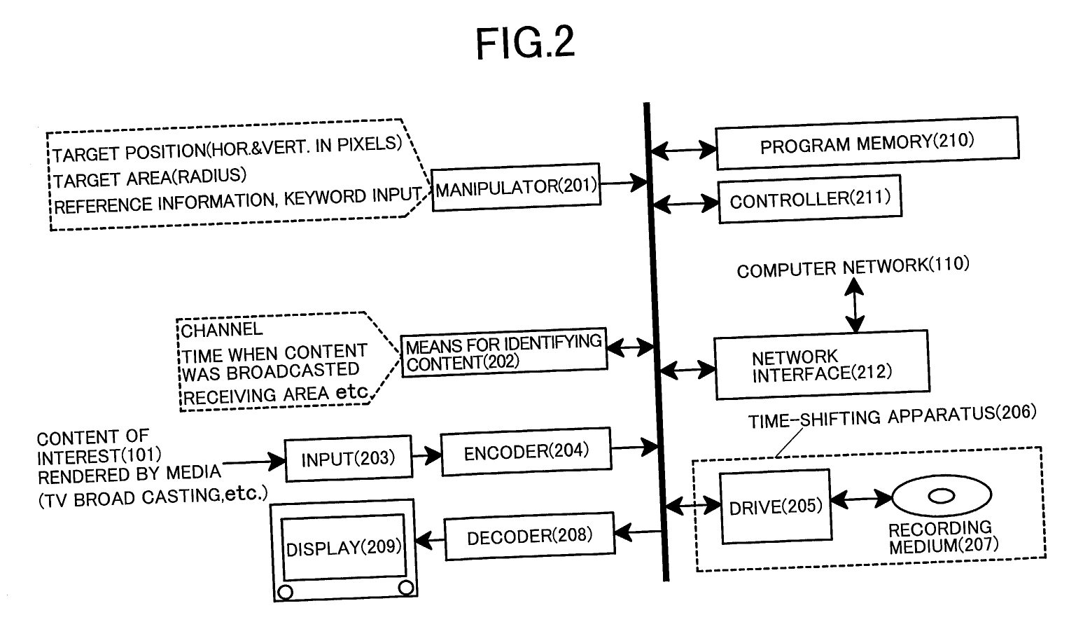

FIG. 2 shows a detailed structural drawing of the information registering equipment and the information viewing equipment. The information registering equipment and the information viewing equipment can be embodied in substantially the same structure. Based on the instructions of a software program comprising the steps which will be described later, stored in a program memory (210), a controller (211) controls the overall operation of the equipment. When the content of interest (101) rendered by media is supplied through the input (203) which will be described later, it is first encoded by an encoder (204) so that it can be handled as digital data under the controller. For this encoding, methods in compliance with the ISO/IEC standards, such as Moving Picture Experts Group (MPEG) and Joint Photographic Experts Group (JPEG), and moreover, Pulse Coded Modulation (PCM) that is a simple binary coding method are applicable. Because any of the commonly well-known methods can be used for encoding, a drawing thereof is not shown. During encoding, not only video signals, but also audio signals may be encoded in the same way. Encoded signals are decoded by a decoder (208) when information is presented on the display (209). In addition to decoding the encoded video/audio signals, the decoder is capable of interpreting and visualizing an HTML document or the like to display reference information. The equipment configuration may include a time-shifting apparatus (206) into which the output from the encoder (204) is stored once. After a certain time interval, the time-shifting apparatus outputs the encoded data to the decoder (208). The time-shifting apparatus is comprised of a recording medium (207) and a drive (205) that drives the medium for recording/reproducing data to/from the medium. As the recording medium, a disc-form medium as shown (for example, a compact disc (CD), digital versatile disc (DVD), magneto-optical (MO) disc, floppy disc (FD), hard disc (HD) etc.) may be used. In addition, a tape-form medium (such as videocassette tape) and a solid-state memory (such as a flash memory) may be used. Because the time-shifting apparatus can be embodied by using a general recording apparatus as is, a drawing thereof is not shown. As for the input and display, the corresponding functions of other devices can be used instead of them (that is, they can be provided as attachments). Therefore, they may be excluded from the configuration of the information registering equipment and the information viewing equipment.

Means for identifying content (202) obtains and retains information to identify the content of interest (channel, time when content was broadcasted, receiving area, etc.), based on the data entered through the input (203) which will be explained later. If the time-shifting apparatus (206) is used, when video/audio signals are recorded, the information to identify the content can also be recorded. When reproduction is performed, that information is transferred from the time-shifting apparatus to the means for identifying content.

A manipulator (201) allows the user to define the target position (horizontal and vertical positions in pixels) and the target area (within a radius from the target position) on the image presented on the display (209), the image to which reference information is desired to link or whose reference information is desired to be retrieved, based on the coordinates data furnished with the pointing device which will be explained later. Moreover, the manipulator allows for specifying reference information and keyword information (input via the keyboard, dragging and dropping the label or the like of an HTML document, selecting from a displayed list, and so on). If the time-shifting apparatus is used, defining the target position/area and specifying reference information may be carried out when video/audio signals are reproduced. The operation of a network interface (212) will be described below. Through the network interface, the information registering equipment receives keyword information carried over a computer network and transmits the information to identify the content of interest retained by the means for identifying content, content/object identifying information including the target position/area defined through the manipulator, and reference information and keyword information specified through the manipulator over the computer network. On the other hand, through the network interface, the information viewing equipment receives keyword information carried over the computer network and transmits the information to identify the content of interest retained by the means for identifying content, content/object identifying information including the target position/area defined through the manipulator, and keyword information specified through the manipulator over the computer network. Then, the information viewing equipment receives results of search returned from the information search equipment over the computer network. In either case, the network interface only provides the functions of transmitting and receiving commands and data across the computer network to/from the information search equipment. Because the network interface can be embodied by using a network interface board or the like for general PCs, a drawing thereof is not shown.

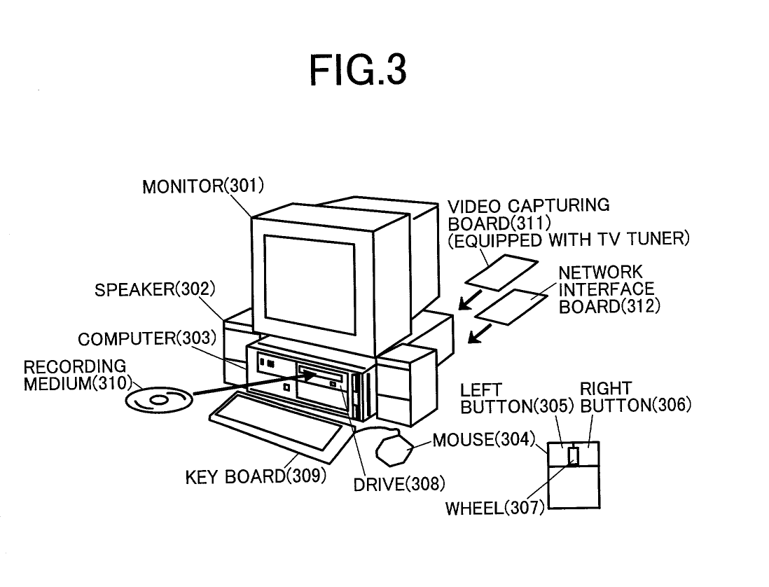

FIG. 3 shows a structural drawing in another form of the information registering equipment (102) and the information viewing equipment (103). FIG. 3 illustrates an example of general PC-form embodiment of the configuration of the information registering equipment and the information viewing equipment shown in FIG. 2. The equipment is comprised of a monitor (301), speaker (302) computer (303), mouse (304), drive (308), recording medium (310), keyboard (309), video capturing board (311), and network interface board (312). By contrast with the configuration shown in FIG. 2, the equipment shown in FIG. 3 is configured with the mouse (304) and keyboard (309) in place of the manipulator (201), the video capturing board (311) in place of the input (203), encoder (204), and decoder (205), the monitor (301) and speaker (302) in place of the display (209), the drive (308) in place of the drive (205), the recording medium (310) in place of the recording medium (207), and the network interface board (312) in place of the network interface (212). Instead of the means for identifying content (202), the main memory built in the computer (303), is used to retain the results of operations executed by the controller (211). As the user moves the mouse (304), the cursor shown on the monitor (301) moves to a desired place. By pressing, for example, the left button (305) of the mouse, the target position is defined. Defining the target area can be performed as follows. Move the wheel (307) of the mouse forward (up) to extend the area and move the wheel backward (down) to diminish the area. The right button (306) of the mouse may be used to display help for explaining operation. The video capturing board (311) is equipped with a TV tuner function so that channel selection and tuning can be performed under the software control from the computer. Other forms of equipment configuration than the one shown in FIG. 3 include a TV receiver or the like into which the functions shown in FIG. 2 are incorporated.

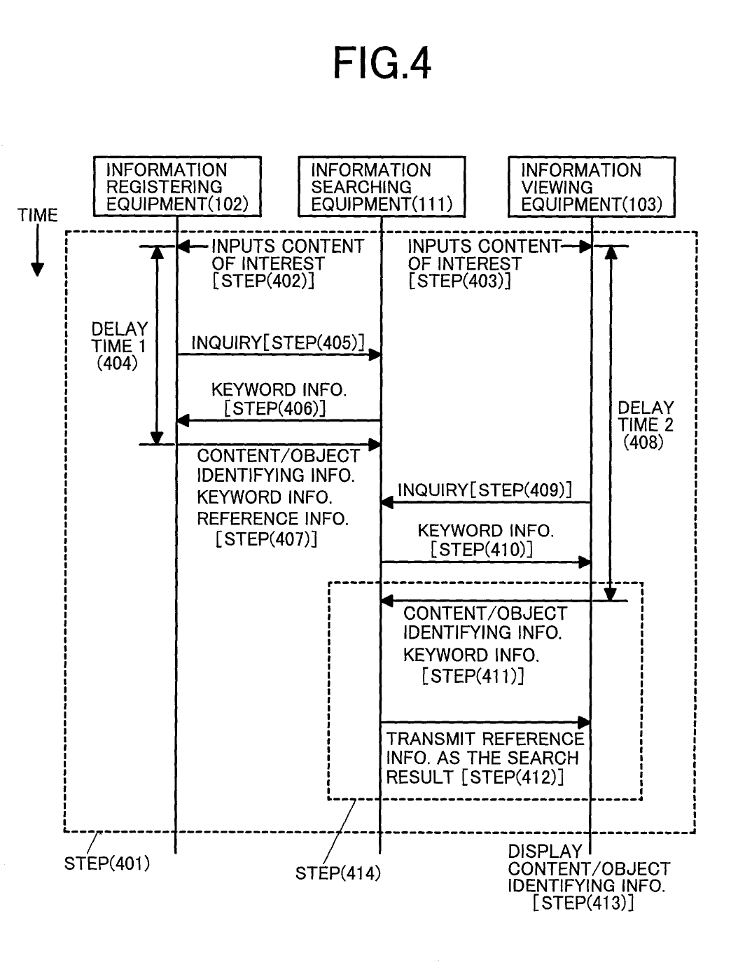

FIG. 4 illustrates an example of information linking operation according to the present invention.

FIG. 4 represents the actions of the information registering equipment (102), information search equipment (111), and information viewing equipment (103) shown in FIG. 1 as steps (401) that are carried out with time lags. First, in steps (402) and (403), the same content of interest rendered by media is input to the information registering equipment and the information viewing equipment at the same time. This does not mean that the content of interest is input only at this moment. In other words, during continues rendering of content by media, when the content of interest may-be captured and input at any time, the image display content at this moment is input for the process for registering and viewing of reference information. At this time, a finite processing time is required for registering and viewing the reference information. Especially in cases where recording/reproducing are performed with the above-mentioned time-shifting apparatus (206), the time allowed for processing may be very long; e.g., a few days or longer. Thus, generally, there occurs some difference between delay time 1 (404) after the input of the content of interest to the information registering equipment (102) in step (402) until transmitting the content/object identifying information, keyword information, and reference information in step (407) and delay time 2 (408) after the input of the content of interest to the information viewing equipment (103) in step (403) until transmitting the content/object identifying information and keyword information in step (411). In FIG. 4, the actions proceed, assuming that delay time 1 (404) is shorter than delay time 2 (408), that is, the process of registering information is completed before the process of viewing the reference information.

An example of the method of registering information is first illustrated below. The information registering equipment makes inquiry about keywords to the information search equipment in step (405). If keyword information has previously been registered on the information search equipment, the information search equipment transmits keyword information in a list to the information registering equipment in step (406). Thus, the information registering equipment obtains the keyword list. By inquiring keywords and obtaining the keyword list which, the information registering equipment, however, may not carry out, this enables its user to select a keyword from a list of keywords registered beforehand. The information registering equipment transmits the content/object identifying information, keyword information, and reference information to the information search equipment in step (407). The information search equipment registers each of the above information into the database, whereat the process of registering information is completed. Keyword information may be either the one selected from the keyword list or a newly entered keyword. The content/object identifying information and reference information are those as described above.

Then, an example of the method of information search and retrieval is illustrated below. The information viewing equipment makes inquiry about keywords to the information search equipment in step (409). If keyword information has previously been registered on the information search equipment, the information search equipment transmits keyword information in a list to the information viewing equipment in step (410). Thus, the information viewing equipment obtains the keyword list. By inquiring keywords and obtaining the keyword list which, the information viewing equipment, however, may not carry out, this enables its user to select a keyword from a list of keywords registered beforehand. By applying the above-described method, the information viewing equipment transmits the content/object identifying information and keyword information to the information search equipment in step (411). On the information search equipment (111), this data of each of the above information is compared with the corresponding data within all data records stored in its database including the data received from the information registering equipment in the step (407) one by one for matching. If a data record meeting the conditions of search is found, the information search equipment transmits reference information derived from the data record to the information viewing equipment (103) in step (412). The information viewing equipment displays the reference information it received in step (413), whereat information retrieval is completed. The block identified by step (414) signifies information exchange between the information search equipment and the information viewing equipment when reference information search and retrieval are performed. The content/object identifying information, keyword information, and the method of information search and retrieval are as described above.

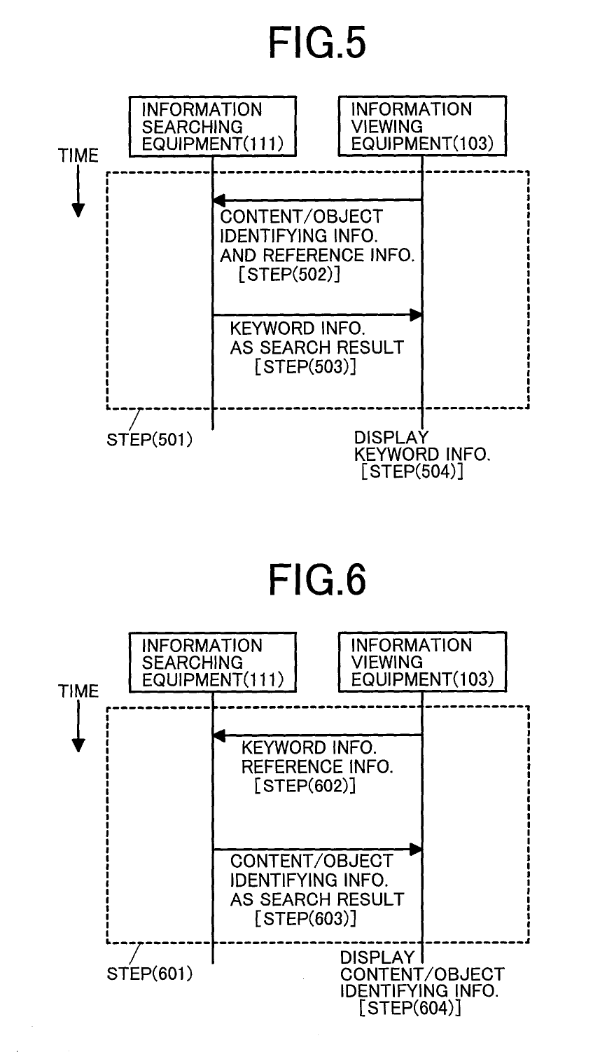

FIG. 5 illustrates another example of the method of information search and retrieval. The block identified by step (501) signifies information exchange that is performed to retrieve keyword information, instead of the step (414) in the method of information search and retrieval illustrated in FIG. 4. By applying the above-described method, the information viewing equipment transmits the content/object identifying information and reference information to the information search equipment in step (502). On the information search equipment (111), this data of each of the above information is compared with the corresponding data within all data records stored in its database including the data received from the information registering equipment in the step (407) one by one for matching. If a data record meeting the conditions of search is found, the information search equipment transmits keyword information derived from the data record to the information viewing equipment (103) in step (503). The information viewing equipment displays the keyword information it received in step (504), whereat information retrieval is completed.

FIG. 6 illustrates yet another example of the method of information search and retrieval. The block identified by step (601) signifies information exchange that is performed to retrieve content/object identifying information, instead of the step (414) in the method of information search and retrieval illustrated in FIG. 4. By applying the above-described method, the information viewing equipment transmits keyword information and reference information to the information search equipment in step (602). On the information search equipment (111) this data of each of the above information is compared with the corresponding data within all data records stored in its database including the data received from the information registering equipment in the step (407) one by one for matching. If a data record meeting the conditions of search is found, the information search equipment transmits content/object identifying information derived from the data record to the information viewing equipment (103) in step (603). The information viewing equipment displays the content/object identifying information it received in step (604), whereat information retrieval is completed.

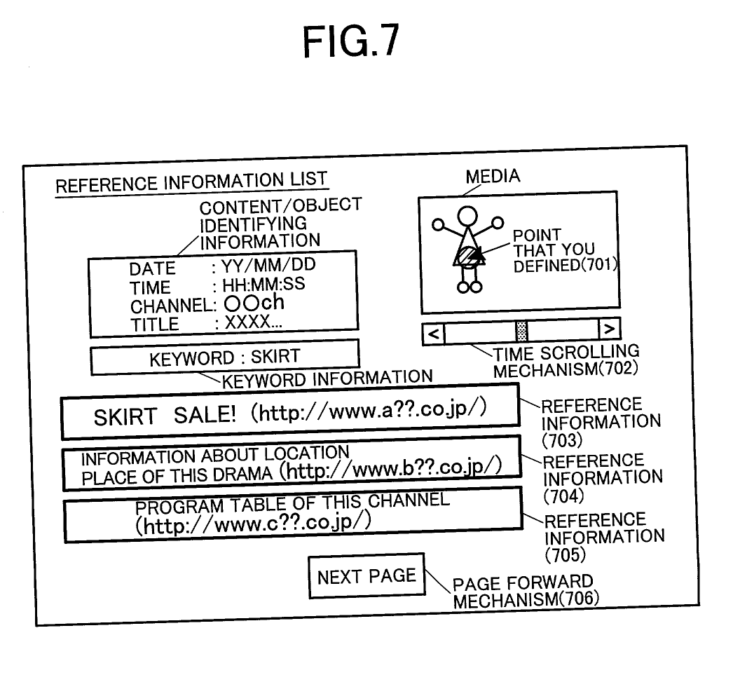

FIG. 7 illustrates an example of the reference information displayed on the information viewing equipment of the present invention. As shown in FIG. 7, the content/object identifying information, the content of interest rendered by media, and the related keyword information are displayed to tell the viewer what content of interest for which its reference information has been retrieved. The defined target area (701) may be shown, superposed on the content of interest. With this display, a time scrolling mechanism (702) may be employed so that a scene (motion video sequence) in several seconds before and after the specified point (time) can be displayed, which enables the viewer to recall the scene of interest more definitely and recognize the search of its reference information. The motion video sequence can be read from the above-mentioned time-shifting apparatus. Reference information items (703) (704) (705) are those of reference information that has been registered by the information registering equipment. Assuming that a plurality of reference information items are presented on the same display at a time as in this example, as the reference information, displaying their titles in several words with URLs where their HTML documents (reference information) have been stored is preferable to directly displaying text documents or the like, because more information can be displayed at a time. In cases where URLs are specified as the reference information, select the appropriate URL, then the HTML document that the URL points to is displayed on the information viewing equipment. For selecting an URL and displaying its HTML document, the same function is applied as the browser software for general PCs and therefore a drawing thereof is not shown. If the registered items of reference information are so many that they cannot be displayed on one page, a page forward mechanism (706) and a page turn-back mechanism may be employed so that the user can let the display page go forward and backward.

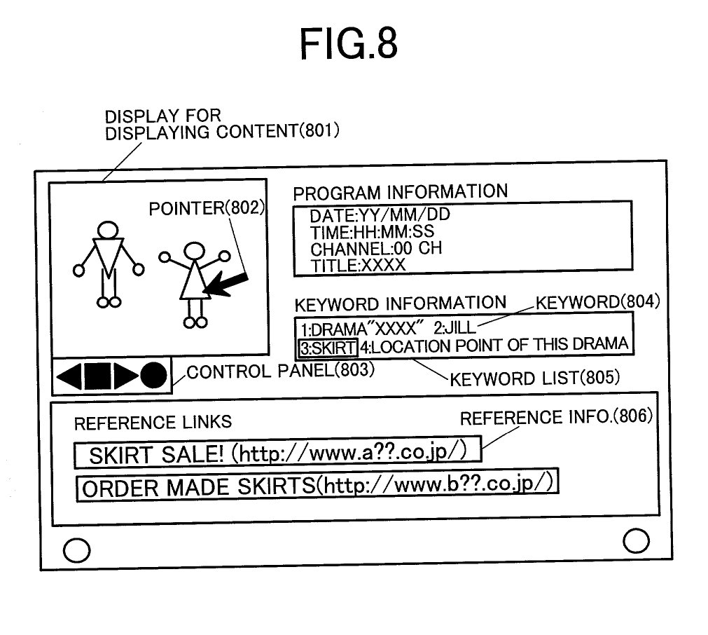

FIG. 8 illustrates an example of displaying content on the display of the information viewing equipment of the present invention. On the information viewing equipment, reference information is retrieved by using target image object information in the following procedure. In FIG. 8, the user selects an image at a specified time frame from the content of interest rendered by media, using a control panel (803). Then, the user selects desired area or point on the image shown on the display (801) for displaying content, using a pointer (802). Thus, content/object identifying information is determined that comprises information identifying the content of interest, time information, target area information, etc. The information viewing equipment transmits the content/object identifying information across the computer network to the information search equipment. The information viewing equipment receives reference information (806) retrieved as the result of search and displays it. Moreover, reference information is retrieved by using keywords in the following way. In FIG. 8, the user selects a keyword out of a keyword list (805) which has been received beforehand by accessing the information search equipment or enters a new keyword. The information viewing equipment transmits the thus specified keyword to the information search equipment and then receives reference information (806) retrieved as the result of search and displays it. Preferably, it is advisable to specify a keyword and target image object information together at the same time so that search for reference information will be performed by the combination of the keyword and object information. This enables search for information, for example, information linked with the specified keyword out of the reference information linked with the specified area on video images displayed for the specified time length. When keywords are displayed in the keyword list form, the order in which the keywords are arranged is determined, according to the number of reference information items linked with the keyword, the number of times user access to the keyword has occurred, time at which the keyword was recorded, etc. for each keyword. This can make the presentation of keyword information easy to understand for the user.

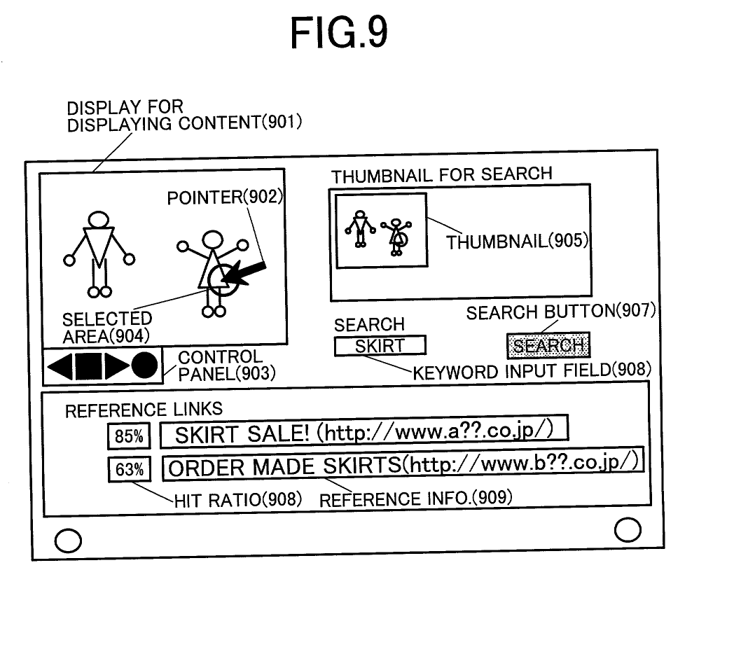

FIG. 9 illustrates another example of displaying content on the display of the information viewing equipment of the present invention. On the information viewing equipment, reference information is retrieved by using target image object information together with keyword information in the procedure that will be detailed below. In FIG. 9, the user selects an image at a specified time frame from the content of interest rendered by media, using a control panel (903). Then, the user selects desired area or point on the image shown on the display (901) for displaying content, using a pointer (902). Thus, content/object identifying information is determined that comprises information identifying the content of interest, time information, target area information, etc. In this embodiment, as an example, a circle is defined as the selected area (904). When the user has determined the content/object identifying information, a thumbnail (905) of the selected image is displayed so that the user can easily recognize the user-specified information. In FIG. 9, the user enters a keyword in the keyword input field (906), thereby determining the keyword information. After specifying the content/object identifying information and keyword information, the user presses the search button (907), whereupon search for reference information starts. At this time, the information viewing equipment transmits the content/object identifying information and keyword information across the computer network to the information search equipment. Then, the information viewing equipment receives reference information (909) retrieved as the result of search and displays it. The method of information search and retrieval using content/object identifying information and keyword information is as described above. When displaying retrieved items of reference information, the items of reference information are ordered by using hit ratio (908) information or the like and presented to the user in the thus determined order. A method of ordering the items is as follows. For example, the circle as the selected area (904) that has been transmitted from the information viewing equipment and the circle as the target image object registered on the information search equipment are compared. A ratio of the overlap of the two circles to the total area of the circles is calculated as the hit ratio. Among the items of reference information to be presented, an item with the highest ratio is placed at the top and other items are placed, according to their ratio. In another method thereof, for the items of reference information and keyword information, the number of times user access to each item has occurred is recorded. An item with the greatest number of times it has been accessed is placed at the top and other items are placed, according to the ranking in this number. A further method thereof is as follows. For the items of reference information to be presented, an item matched with both content/object identifying information and keyword information is placed at the higher position, and an item matched with either information is placed at the lower position. The foregoing methods may be combined, wherein ordering is determined by executing logical calculation. The above-recited methods can make the presentation of reference information easy to understand for the user.

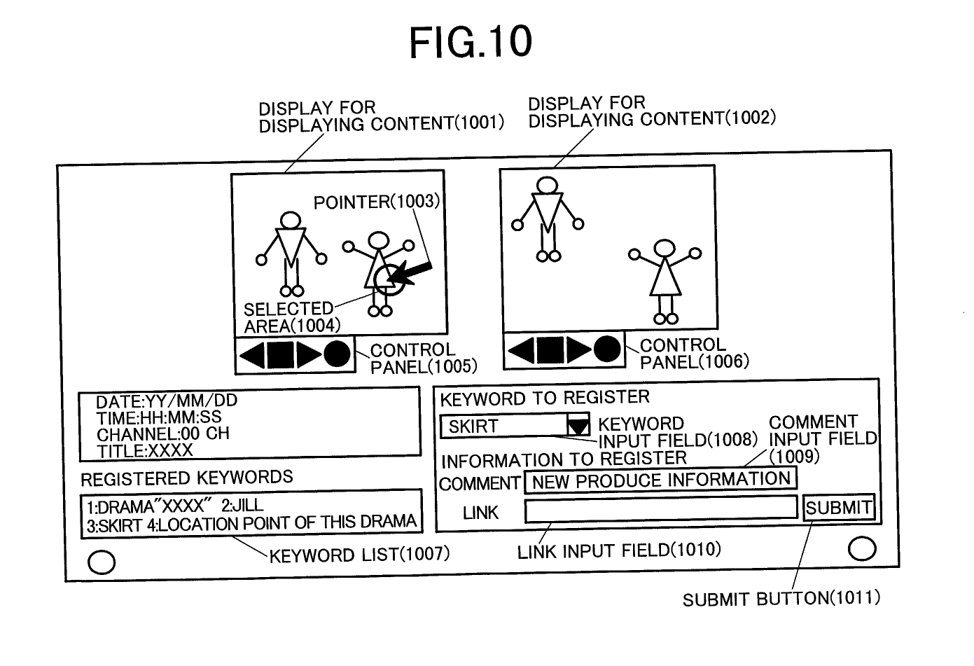

FIG. 10 illustrates an example of displaying content on the displays of the information registering equipment of the present invention. In FIG. 10, the user selects an image at a specified time frame from the content of interest rendered by media, using a control panel (1005). Then, the user selects desired area (1004) on the image shown on one display (1001) for displaying content, using a pointer (1003), thereby specifying the target area. In this embodiment, for example, two displays for displaying content (1001) (1002) and two control panels (1005) (1006) are prepared. Using the display (1001) and the control panel (1005), the user can specify the time of the beginning frame and the area of an object as the target area to register. Using the display (1002) and the control panel (1006), the user can specify the time of the ending frame and the area of an object. Then, the user enters a keyword to register, concerning reference information in the keyword input field (1008), comment about reference information in the comment input field (1009), an address to which to link to get reference information in the link input field (1010), and presses the submit button (1011). When the submit button is pressed, the information registering equipment puts the information identifying the content of interest specified by the user, the target area selected, time information, and the like together into the content/object identifying information. The information registering equipment transmits the content/object identifying information, together with the keyword information and the reference information such as comment and the link-to-address, across the computer network to the information search equipment. The information search equipment registers the above-recited information into the database. Keyword information may be specified and registered in such a manner as will be described below. By accessing the information search equipment beforehand, the information registering equipment receives keyword information therefrom and displays a keyword list (1005) from which the keywords are automatically shown in the keyword input field and the user may select a desired keyword.

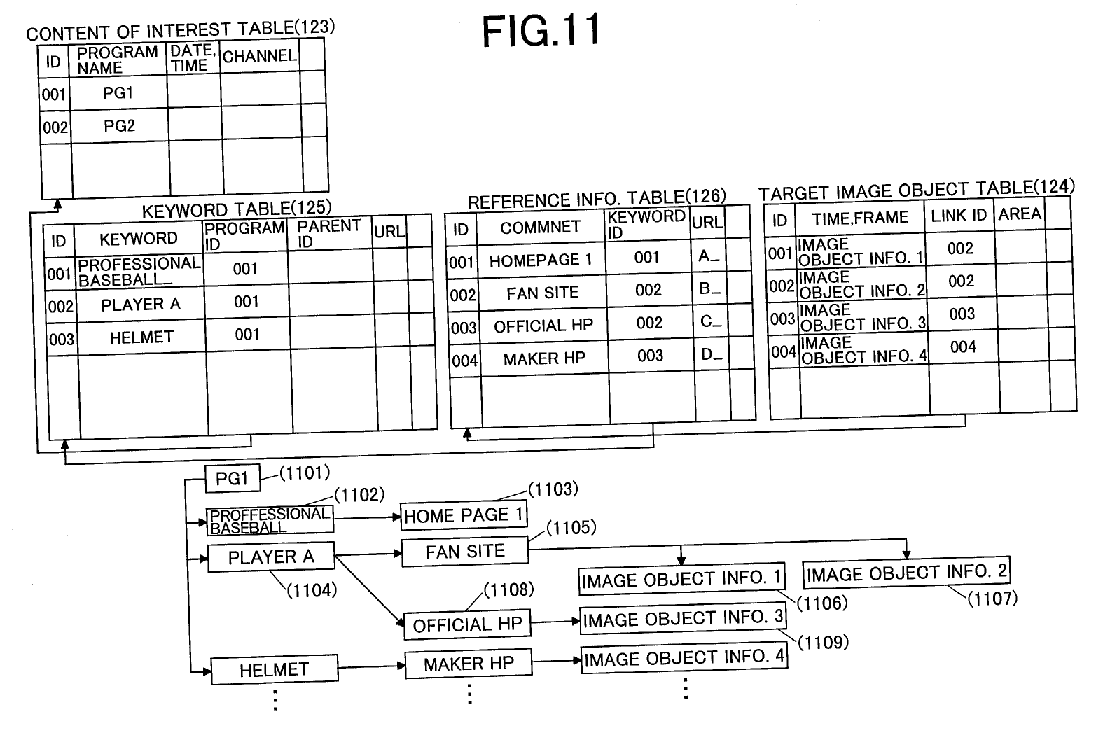

FIG. 11 illustrates an example of the method of storing data into the database of the information search equipment, wherein data tables are provided for sorting the data. In this embodiment, a method of data management using the content of interest table (123), keyword table (125), reference information able (126), and target image object table (124) is illustrated. The content of interest table is provided for managing the data for the registered TV broadcast programs. In this table, an ID number is assigned to each program and per-program management is made for information such as date/time when the program started and the channel over which the program was broadcasted. As an example, linked with “PG1” (program 1) (1101) entered in the content of interest table, its keyword and reference information received from the information registering equipment are registered into other tables as follows.

First, registering “professional baseball” (1102) as the keyword information and “home page 1” (1103) as the reference information will be explained below. First, a new ID is assigned to an entry in the keyword table, and on this entry line, the keyword “professional baseball” and “001” that is the ID of “PG1” as the associated program ID are entered. For the reference information table, a new ID is assigned to an entry in this table, and on this entry line, “home page 1” as comment, “001” as Keyword ID that is the associated keyword ID, and the address of the linked home page as URL (symbolized with A . . . ) are entered. The keyword table may be arranged to include further fields such as a Parent ID field, URL field, and access count field to indicate the number of times the keyword has been selected. The Parent ID field is to contain a keyword ID for hierarchical management of keywords. The URL field is to contain the address of a Web site/page (home page) particularly created for the keyword, where a bulletin board system is provided for talks about the keyword. The reference information table may be arranged to include further fields for the priority of the reference information and its access count to indicate the number of times it has been selected. If, for example, the Parent ID field is used, relationship between keywords can be registered, wherein keywords are classified by category or in other way and this can make the presentation of keyword information easy to understand for the user.

Then, an illustrative case in which “image object 1” (1106) and “image object 2” (1107) are specified as the target area within the content/object identifying information and “player A” (1104) as keyword information and “FAN site” (1105) as reference information are registered will be explained below. First, a new ID is assigned to an entry in the keyword table, and on this entry line, the keyword “player A” and “001” that is the ID of “PG1” as the associated program ID are entered. For the reference information table, a new ID is assigned to an entry in this table, and on this entry line, “FAN site” as comment, “002” as Keyword ID that is the associated keyword ID, and the address of the linked home page as URL (symbolized with B . . . ) are entered. In the target image object table, new IDs are assigned to the entries for “image object 1” and “image object 2,” and on these entry lines, “002” as the ID of the reference information associated with these objects are entered in the Link ID field. The target image object table includes the fields for time and target image object information such as time at which and a frame number on which the image object was captured and defined area of the object. The target image object information can be used for judging whether the clicked position falls within the previously defined and registered area, and a method thereof will be described later.

Furthermore, an illustrative case in which, linked with the previously registered keyword “player A,” “image object 3” (1109) as target area information and “official HP” (1108) as reference information are registered will be explained below. In the keyword table, the keyword “player A” has been registered before. For the reference information table, a new ID is assigned to an entry in this table, and on this entry line, “official HP” as comment, “002” as Keyword ID that is the associated keyword ID, and the address of the linked home page as URL (symbolized with C . . . ) are entered. In the target image object table, a new ID is assigned to the entry for “image object 3,” and on this entry line, “003” as the ID of the reference information associated with the object is entered in the Link ID field.

Searching for reference information from the target image object table is performed as follows. When the matching apparatus is informed of a target image object, it refers to the Link ID on the object's record entry line in the target image object table and searches the reference information table for a record entry having that ID. Thereby, the reference information record matched with the object can be obtained. Searching for reference information from the keyword table is performed as follows. When the matching apparatus is informed of a keyword, it obtains the keyword's record entry ID in the keyword table, compares this ID with the Keyword ID of each record entry in the reference information table, and selects the record entry with the matched ID. Thereby, the reference information record matched with the keyword can be obtained. By applying the above-described management method, management of reference information and keywords without target image object information is also possible. Moreover, it becomes possible to manage a plurality of reference information with the same keyword. By independent management of the keyword table, the keyword search process can be omitted when a keyword list is created. An alternative manner of managing keyword information in which keyword fields are incorporated into the reference information table may be applied.

Registering information into the database is performed when the information registering equipment has just accessed the information search equipment. The information within linked records across the tables is altered in one transaction when the access thereto occurs, so that the consistency across the tables will be maintained. As for the method hereof, a commonly used database maintenance method may be applied. Not only registering, but also altering or deleting information is performed in the same way.

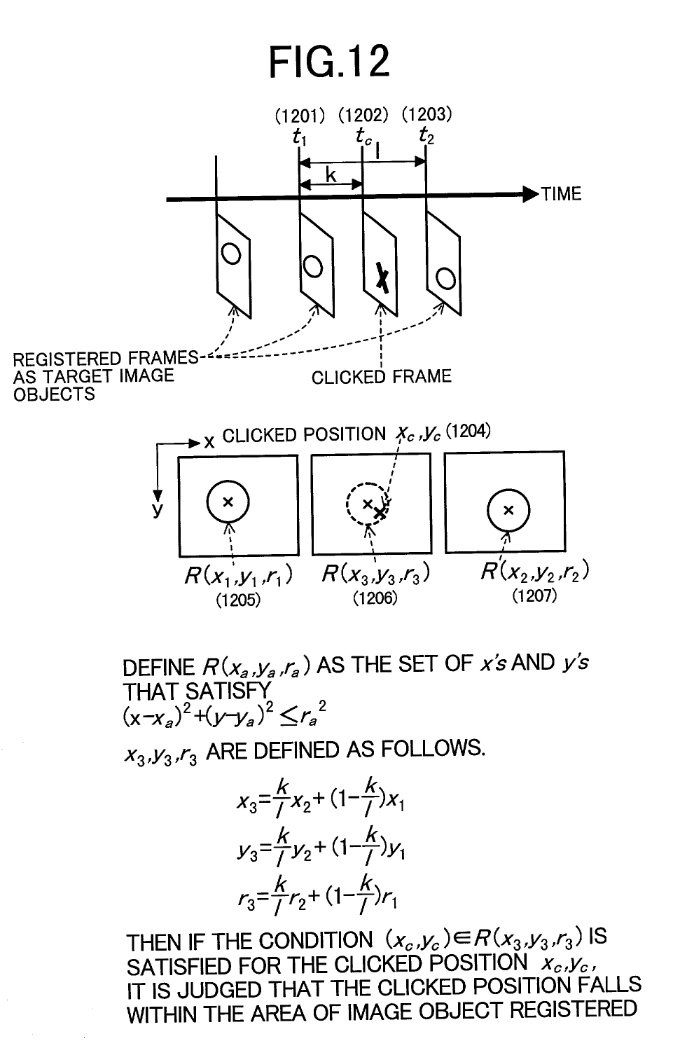

When the user clicks at a point on an image displayed, whether the clicked position falls within the previously defined area included in the information registered as image object/time length information is judged in a method that is illustrated in FIG. 12. The image object/time length information consists of the area of the object that is defined on the image displayed and the time length during which the object is displayed. Using a circle as an example of the defined area of the object, the method for the above judgment is explained below. Assume that frames from the starting frame at time t₁ (1201) to the ending frame at time t₂ (1203) are registered as the time length within the image object/time length information (where t₁<t₂). Using x and y as the coordinates of a point on the displayed image and r as the radius of a circle, R (xₐ, yₐ, rₐ) represents the set of the x and y values that satisfy the following:

(x−xₐ)²+(x−xₐ)²≦rₐ² [Conditional inequality 1]

The circle area defined at time t₁ (1201) is described by R (x₁, y₁, r₁,) (1205) and the circle area defined at time t₂ (1203) by R (x₂, y₂, r₂) (1207). Information for the circle areas described by these area parameters x, y, r and time t is described by I₁ (x₁, y₁, r₁, t₁) and I₂ (x₂, Y₂, r₂, t₂). Suppose that I₁ and I₂ have already been registered in the database of the information search equipment. On the frame at time t_{c} (1202), when a point of coordinates (x_{c}, y_{c}) (1204) is clicked, whether the clicked position falls within the previously registered area is judged. Information including the coordinates (x_{c}, y_{c}) and time t_{c} (1202) is transmitted from the information viewing equipment to the information search equipment. Difference between time t₁ (1201) and time t₂ (1203) is assumed to be 1; that is, 1=t₂−t₁. Difference between time t₁ (1201) and time t_{c} (1202) is assumed to be k; that is, k=t_{c}−t₁. At time t_{c}, where t₁<t_{c}<t₂, when the point of coordinates (x_{c}, y_{c}) was clicked, define values of x₃, y₃ and r₃ of R (x₃, y₃, r₃) that satisfy the following equations 2, 3, and 4:

$${x}_{3} = \frac{k}{l} {x}_{2} + ( 1 - \frac{k}{l} ) {x}_{1} \qquad [ Equation 2 ]$$

$${y}_{3} = \frac{k}{l} {y}_{2} + ( 1 - \frac{k}{l} ) {y}_{1} \qquad [ Equation 3 ]$$

$${r}_{3} = \frac{k}{l} {r}_{2} + ( 1 - \frac{k}{l} ) {r}_{1} \qquad [ Equation 4 ]$$

If the relationship between the thus obtained R (x₃, y₃, r₃) and the coordinates (x_{c}, y_{c}) satisfies the following relation 5, it is judged that the clicked position falls within the area of the image object registered.

(x_{c}, y_{c})εR(x₃, y₃, r₃) [Relation 5]

This method is considered as linear interpolation for the circle described by R (x₁, y₁, r₁) and the circle described by R (x₂, y₂, r₂) along the time axis, wherein whether the position clicked on the intermediate frame falls within the previously defined and registered area is judged. In this way, by registering the image object/time length information, when the user clicks at a point on an image displayed and the information viewing equipment transmits the clicked position/area information to the information search equipment, judgment can be made as to whether information is linked with the user-clicked position. This method is an example illustrative of judging whether clicked position falls within the previously defined and registered area, based on the image object/time length information. Other methods can be applied. Data in other forms may be used as the image object/time length information.

The above-described embodiment discussed illustrative cases where the content of interest is rendered by general TV broadcasting using transmission media such as terrestrial broadcasting, broadcasting satellites, communications satellites, and cables. The present invention is not limited to this embodiment. In this invention, information (data) that is rendered in various modes is applicable, including motion and still video contents which are distributed across computer networks such as the Internet, motion and still video data for which where the content of interest is stored is made definite by the information to identity the content, for example, the address of a general Web site/page on the Internet, and so on. While defining the target area was illustrated by defining a circle as the target area to simplify the explanation, other shapes, for example, rectangles and polygons may be used in defining the target area.

By applying the present invention, the following is made possible. When watching a TV program, by selecting a part or all of an image displayed on the TV receiver and/or entering or selecting a keyword, other source information related to the image will be retrieved from the database and presented to the viewer.

While the present invention has been described above in conjunction with the preferred embodiments, one of ordinary skill in the art would be enabled by this disclosure to make various modifications to this embodiment and still be within the scope and spirit of the invention as defined in the appended claims.

What is claimed is:

1. A computer program for causing hardware resources to perform a process of information processing, the hardware resources being connected to an information registering equipment and an information viewing equipment by a network and retrieving information from stored data in sets of content/object identifying information, keyword information, and reference information about content of interest rendered by media, said process of information processing comprising the steps of:
obtaining first content/object identifying information that identifies area defined for an object selected from the content of interest, first keyword information, and first reference information about the object within the defined area from said information registering equipment;
linking the first content/object identifying information, the first keyword information, and the first reference information together and storing them into a database;
obtaining second keyword information about an object selected from said content of interest from said information viewing equipment;
comparing the thus obtained first and second keyword information specifics for matching; and
transmitting at least either the first content/object identifying information or the first reference information associated with the first keyword information to said information viewing equipment, according to the result of the matching.

2. A computer program as recited in claim 1, wherein said process of information processing further includes, prior to said step of obtaining the second keyword information, the step of transmitting a list of registered keywords about the object selected from said content of interest to said information viewing equipment in response to inquiry made from said information viewing equipment.

3. A computer program as recited in claim 1, wherein:
said step of obtaining information from said information viewing equipment includes obtaining second content/object identifying information for an object selected from said content of interest;
said step of comparing for matching compares the first and second content/object identifying information specifics for matching; and
said process of information processing further includes the step of transmitting the first reference information associated with the first content/object identifying information and the first keyword information to said information viewing equipment, according to the result of the matching.

4. A computer program as recited in claim 1, wherein:
said step of obtaining information from said information viewing equipment further includes obtaining second reference information about an object selected from said content of interest;
said step of comparing for matching compares ULRs or comments respectively included in the first and second reference information for matching or duplication;
said process of information processing further includes the step of transmitting the first content/object identifying information associated with the first reference information and the first keyword information to said information viewing equipment, according to the result of the matching.

5. A computer program as recited in claim 1, wherein:
said step of comparing for matching determines:
whether one keyword from the first keyword information and the other keyword from the second keyword information match or are duplicate ones;
whether time length associated with the first keyword information and time length associated with the second keyword information match or are duplicate ones in addition to determining whether one keyword from the first keyword information and the other keyword from the second keyword information match or are duplicate ones, or whether time when the first keyword information was registered falls within the time length associated with the second keyword information in addition to determining whether one keyword from the first keyword information and the other keyword from the second keyword information match or are duplicate ones.

6. A computer program as recited in claim 1, wherein:
said step of storing information into the database registers the first content/object identifying information, the first reference information, and the first keyword information into the following tables:
a keyword table having at least an ID field for uniquely identifying a record entry and a keyword field to contain the first keyword, wherein one record entry comprises at least its ID and a keyword;
a reference information table having at least an ID field for uniquely identifying a record entry, a reference information field to contain the first reference information, and a keyword ID field to contain the keyword ID associated with the reference information, wherein one record entry comprises at least its ID, reference information, and the associated keyword ID.
a target image object table having at least an ID field for uniquely identifying a record entry, a time and frame field to contain information to identify an object selected from said content of interest, and an link ID field to contain the ID of reference information linked with the object, wherein one record entry comprises at least its ID, object information, and the ID of reference information linked with the object.

7. A computer program as recited in claim 1, wherein:
said content of interest rendered by media is video image information distributed by TV broadcasting;
said content/object identifying information includes at least any of a broadcasting channel number over which the content was or will be broadcasted, receiving area, specified time length, and target position/area that designates a part or all of an image object;
said keyword information includes at least any of a keyword, keyword ID number, keyword type, specified time length, time when the keyword was registered, and the number of times the keyword has been selected as user preference; and
said reference information includes a URL (Uniform Resource Locator) that designates a Web site/page on the Internet.

8. A computer program for causing hardware resources to implement a process of information processing, the hardware resources allowing for defining area for an object selected from content of interest rendered by media and entering reference information about the object together with the object's keyword information, said process of information processing comprising the steps of:
making inquiry about the object selected from said content of interest to an information search equipment that is connected to said hardware resources by a network;
receiving and displaying keyword information about the object selected from said content of interest from the information search equipment;
allowing for entering content/object identifying information that identifies the area defined for the object selected from said content of interest;
allowing for selecting one or more keywords from the displayed keyword information;
allowing for entering reference information associated with the entered content/object identifying information; and
transmitting the content/object identifying information, the selected keyword or keywords, and the reference information to the information search equipment.

9. A computer program for causing hardware resources to implement a process of information processing, the hardware resources allowing for defining area for an object selected from content of interest rendered by media and viewing reference information associated with keyword information about the object, said process of information processing comprising the steps of:
making inquiry about the object selected from said content of interest to an information search equipment that is connected to said hardware resources by a network;
receiving and displaying keyword information about the object selected from said content of interest from the information search equipment;
allowing for entering content/object identifying information that identifies the area defined for the object selected from said content of interest;
allowing for selecting one or more keywords from the displayed keyword information;
transmitting the selected keyword or keywords and the content/object identifying information to the information search equipment; and
receiving and displaying reference information associated with the content/object identifying information and the keyword information from the information search equipment.
